(19) United States
(12) Patent Application Publication
(10) Pub. No.: US 2010/0287990 A1
(43) Pub. Date: Nov. 18, 2010

(54) METHOD FOR MANUFACTURING GLASS PLATE

(75) Inventor: PI-TSUNG HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/544,237

(22) Filed: Aug. 20, 2009

(30) Foreign Application Priority Data
May 15, 2009 (CN) 200910302367.8

(51) Int. Cl. C03B 23/025

(52) U.S. Cl. 65/107

(57) ABSTRACT

A method for manufacturing a glass plate having a concave surface and an opposite flat surface includes: providing a flat glass plate and a molding die having a concave surface; covering the concave surface of the molding die with the flat glass plate; heating the flat glass plate and the molding die together to intenerate and bend the flat glass plate to form a curved glass plate with a surface thereof facing the molding die attached to the concave surface of the molding die, the curved glass plate having a concave surface facing away from the molding die and a convex surface facing the molding die; and flattening the convex surface of the curved glass plate.

### BACKGROUND

1. Technical Field

The present disclosure relates to methods for manufacturing glass plates and, particularly, to a method for manufacturing glass plate with a concave surface and an opposite flat surface.

2. Description of Related Art

Conventionally, glass plates with a concave surface are manufactured using a mechanical processing method or a hot pressing method. However, in the mechanical processing method, the concave surface of the glass plate needs to be ground using a grinder, the grinding process usually takes a lot of time, and precision when grinding the concave surface is difficult to control. In the hot pressing method, pressure is applied on the glass plate to form the concave surface, but this results in the glass plate usually having a bad appearance because of the distribution of pressure applied on the glass plate is uniformly.

What is needed, therefore, is a method for manufacturing glass plate to overcome or at least mitigate the above-described problem.

### BRIEF DESCRIPTION OF THE DRAWINGS

Many aspects of the present method for manufacturing glass plate can be better understood with reference to the accompanying drawings. The components in the drawings are not necessarily drawn to scale, the emphasis instead being placed upon clearly illustrating the principles of the present method for manufacturing glass plate. In the drawings, all the views are schematic.

FIG. 1 is a flowchart of a method for manufacturing a glass plate according to an exemplary embodiment.

FIG. 2 is a schematic view of a glass plate with a concave surface and an opposite flat surface according to an exemplary embodiment.

FIG. 3 is a schematic view of a flat glass plate and a molding die according to an exemplary embodiment.

FIG. 4 is a schematic view of a curved glass plate curved from the flat glass plate of FIG. 3.

FIG. 5 is a cross-sectional view of the trimmed curved glass plate taken along the line V-V of FIG. 4.

FIG. 6 is a magnified view of the portion VI of the trimmed curved glass plate of FIG. 5.

FIG. 7 is a cross-sectional view of the curved glass plate of FIG. 5 after the edges thereof being rounded.

FIG. 8 is a magnified view of the portion VIII of the curved glass plate of FIG. 7.

FIG. 9 is a cross-sectional view of the curved glass plate of FIG. 7 after a convex surface thereof being flattened.

### DETAILED DESCRIPTION

Embodiments of the present disclosure will now be described in detail below, with reference to the accompanying drawings.

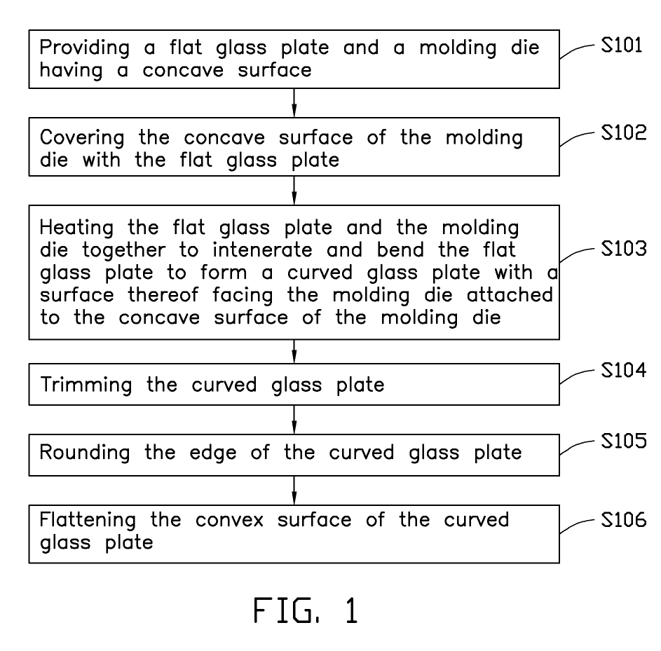

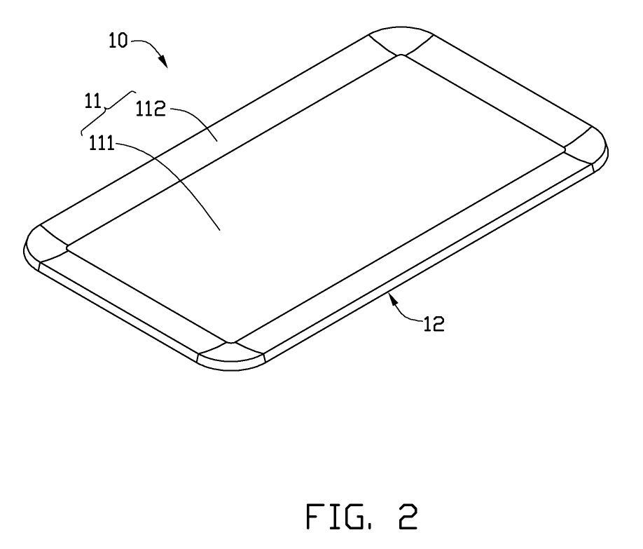

Referring to FIGS. 1 and 2, FIG. 1 is a flowchart of a method for manufacturing a glass plate 10 shown in FIG. 2. The glass plate 10 includes a first surface 11 and a second surface 12 opposite to the first surface 11. The second surface 12 is a flat surface. The first surface 11 is a concave surface with a flat surface 111 located in the center thereof and a curved surface 112 surrounding the flat surface 111.

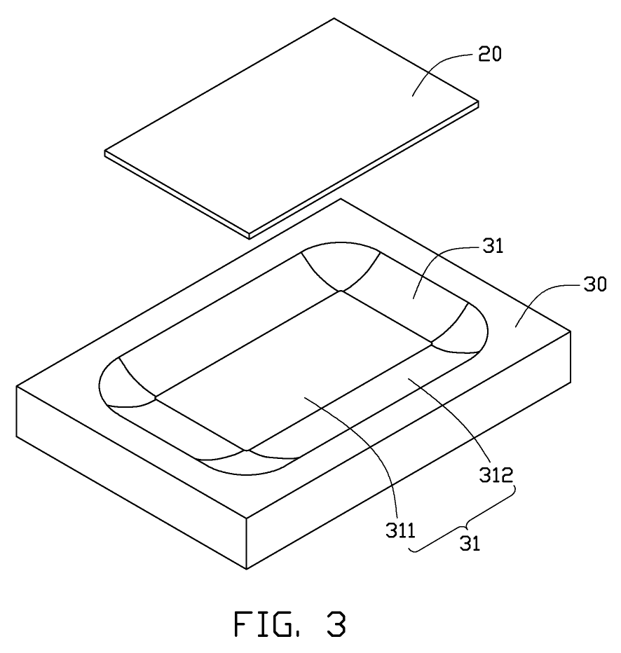

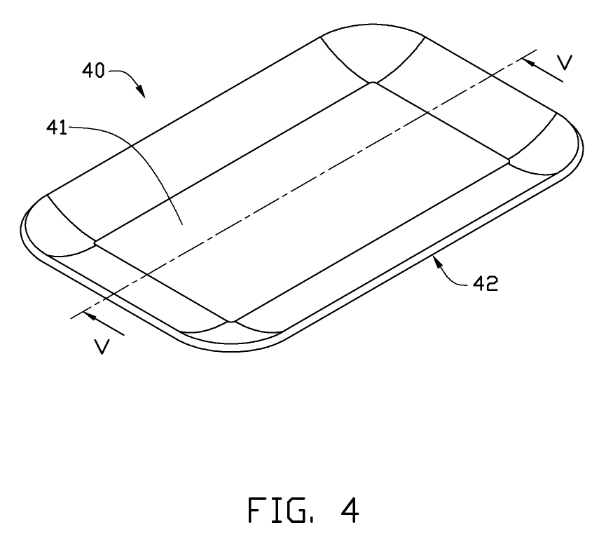

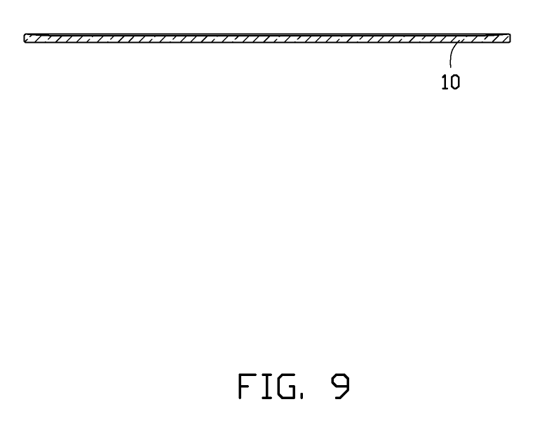

Further referring to FIGS. 3-9, the method for manufacturing the glass plate 10 includes following steps.

Step S101: providing a flat glass plate 20 and a molding die 30. The molding die 30 has a concave surface 31 including a flat bottom surface 311 and a curved side surface 312 surrounding the bottom surface 311.

Step S102: covering the concave surface 31 of the molding die 30 with the flat glass plate 20.

Step S103: heating the flat glass plate 20 and the molding die 30 together to intenerate and bend the flat glass plate 20 to form a curved glass plate 40 with a surface thereof facing the molding die 30 attached to the concave surface 31 of the molding die 30. The curved glass plate 40 has a concave surface 41 facing away from the molding die 30 and a convex surface 42 facing the molding die 30. In the present embodiment, the flat glass plate 20 bends under force of gravity. The flat glass plate 20 and the molding die 30 are heated for about 10-20 minutes, until the temperature of the flat glass plate 20 and the molding die 30 reaches about 720-780 degree centigrade. Then, keep the temperature of the flat glass plate 20 and the molding die 30 unchanged for about 5-10 minutes to ensure uniform temperature inside and outside of the flat glass plate 20, and bent the flat glass plate 20 to a curved glass plate 40. At last, decrease the temperature of the flat glass plate 20 and the molding die 30 slowly for about 10-20 minutes.

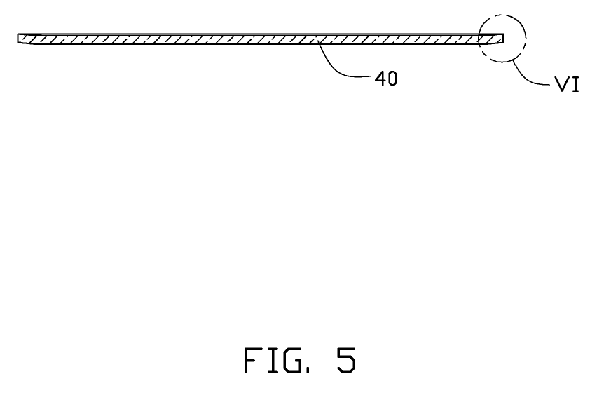

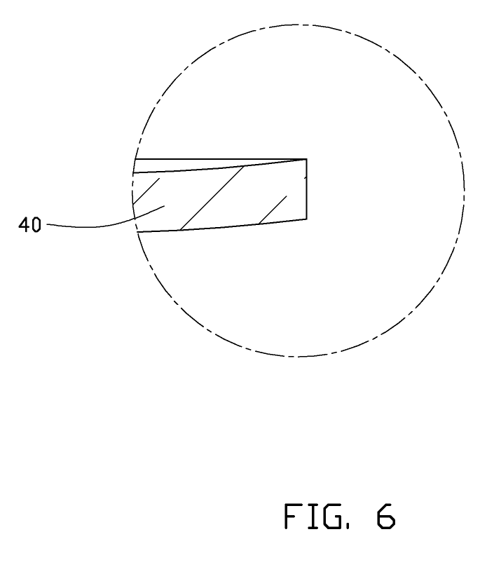

Step S104: trimming the curved glass plate 40. FIGS. 5 and 6 show the curved glass plate 40 after being trimmed.

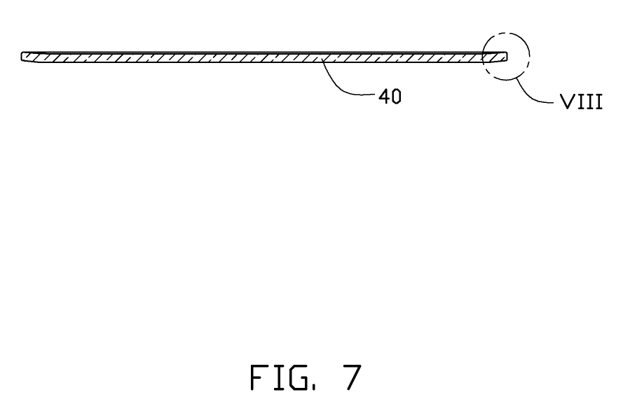

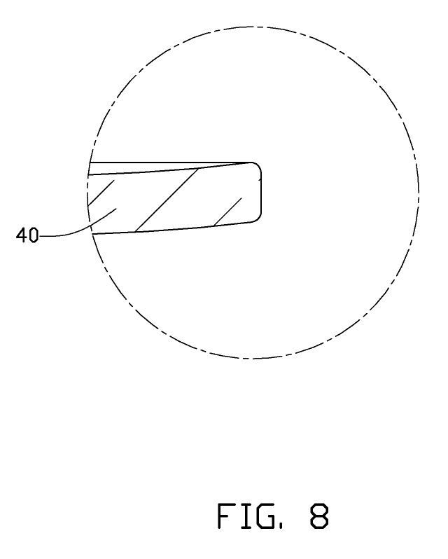

Step S105: rounding the edges of the curved glass plate 40. FIGS. 7 and 8 show the curved glass plate 40 after the edges thereof being rounded.

Step S106: flattening the convex surface 42 of the curved glass plate 40 to get the glass plate 10.

In the present embodiment, the concave surface of the glass plate 10 is formed by thermally bending the flat glass plate 20, the concave surface can be formed easily. In addition, because the gravity applied on the glass plate 10 is uniform, the glass plate 10 will have a good appearance.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope and spirit of the appended claims.

What is claimed is:

1. A method for manufacturing a glass plate having a concave surface and an opposite flat surface, comprising:
providing a flat glass plate and a molding die having a concave surface;
covering the concave surface of the molding die with the flat glass plate;
heating the flat glass plate and the molding die together to intenerate and bend the flat glass plate to form a curved glass plate with a surface thereof facing the molding die attached to the concave surface of the molding die, the curved glass plate having a concave surface facing away from the molding die and a convex surface facing the molding die; and
flattening the convex surface of the curved glass plate.

2. The method as claimed in claim 1, further comprising trimming the curved glass plate after the curved glass plate being formed.

3. The method as claimed in claim 2, further comprising rounding the edges of the curved glass plate.

4. The method as claimed in claim 1, wherein the flat glass plate and the molding die are heated to about 720-780 degree centigrade to intenerate the flat glass plate.

5. The method as claimed in claim 4, wherein the flat glass plate and the molding die are heated for about 10-20 minutes.

6. The method as claimed in claim 5, wherein the temperature of the flat glass plate and the molding die keeps for about 5-10 minutes unchanged during bending the flat glass plate.

7. The method as claimed in claim 6, wherein the time for decreasing the temperature of the flat glass plate and the molding die is about 10-20 minutes.

8. The method as claimed in claim 1, wherein the flat glass plate bends under force of gravity.

9. The method as claimed in claim 1, wherein the concave surface of the glass plate comprises a flat surface located in the center of the concave surface of the glass plate and a curved surface surrounding the flat surface, and the concave surface of the molding die comprises a flat bottom surface and a curved side surface surrounding the bottom surface.
